(19) United States
(12) Patent Application Publication
(10) Pub. No.: US 2008/0152365 A1
(43) Pub. Date: Jun. 26, 2008

(54) IMAGE FORMING APPARATUS AND METHOD OF CONTROLLING THE SAME

(75) Inventors: Soo Cheol Park, Seoul (KR); Bum Kwon Kang, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/954,122

(22) Filed: Dec. 11, 2007

(30) Foreign Application Priority Data
Dec. 22, 2006 (KR) 2006-132879

(51) Int. Cl. G03G 15/00

(52) U.S. Cl. 399/21

(57) ABSTRACT

An image forming apparatus and a method of controlling the same, which control a paper pickup-related time to perform duplex printing, are provided. The apparatus includes a first conveyance path, a second conveyance path, a counter, and a controller. A paper feed unit and a paper exit unit are provided in the first conveyance path where development, transfer, and fusing processes are performed. In the second conveyance path, paper is conveyed separately from the first conveyance path. The counter measures a conveyance period of time, during which a sheet of paper is conveyed along the second conveyance path, based on a sensing signal from a paper feed sensor and a paper exit sensor. The controller controls a paper pickup-related time to perform duplex printing according to the difference between the conveyance period of time measured by the counter and a reference period of time.

### CROSS-REFERENCE TO RELATED APPLICATIONS

This application claims priority under 35 U.S.C. §119(a) from Korean Patent Application No. 2006-0132879, filed on Dec. 26, 2006 in the Korean Intellectual Property Office, the disclosure of which is incorporated herein in its entirety by reference.

### BACKGROUND OF THE INVENTION

1. Field of the Invention

The present general inventive concept relates to an image forming apparatus and a method of controlling the same, and more particularly, to an image forming apparatus and a method of controlling the same, which control a paper pickup-related time to perform duplex printing.

2. Description of the Related Art

A general image forming apparatus includes a plurality of conveying rollers, which are provided along a conveyance path, and a driving unit to drive the conveying rollers.

Setting a too small an interval of time between sheets to be conveyed causes multifeed, which is overlapping conveyance of two consecutive sheets which would otherwise be conveyed separately. Setting too large an interval of time between sheets to be conveyed reduces the printing speed. Thus, a pickup-related time (pickup timing or pickup waiting period) of the next sheet of paper after one sheet of paper is picked up is strictly controlled when a number of sheets of paper are printed.

Especially, a conventional duplex printing apparatus among such image forming apparatuses has a longer conveyance path to perform duplex printing than that of simple printing since the conveyance path to perform duplex printing generally includes two separate sections, one to print on the front side of a sheet of paper and the other to print on the back side after the front side is printed on. In the duplex printing apparatus, the conveyance of a sheet of paper is often delayed due to the long conveyance path.

If the conveyance of a sheet of paper is delayed, the printing apparatus determines that a jam has occurred and stops printing. Even if the printing apparatus determines that no jam has occurred, the delay may cause multifeed and malfunctions during printing.

### SUMMARY OF THE INVENTION

An image forming apparatus and a method of controlling the same, to control a paper pickup-related time if a paper conveyance delay occurs during duplex printing.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming apparatus including a plurality of paper sensors to sense a sheet of paper conveyed along a conveyance path, a counter to measure a conveyance period of time, during which the sheet of paper is conveyed, based on a sensing signal from the plurality of paper sensors, and a controller to control, if the conveyance period of time measured by the counter and a reference period of time are different, a pickup-related time of a next sheet of paper or to display that a jam has occurred according to a difference between the measured conveyance period of time and the reference period of time.

The plurality of paper sensors may include a paper feed sensor to detect feed of a sheet of paper, and a paper exit sensor to detect exit of a sheet of paper.

The controller may control the pickup-related time of the next sheet of paper according to a difference between the reference period of time and a conveyance period of time during which the sheet of paper is conveyed along one section of the conveyance path where an image is formed on a rear side of the sheet of paper.

The controller may delay a default paper pickup-related time by the difference between the conveyance period of time and the reference period of time if the difference is not longer than a jam setting time.

The controller may display that a jam has occurred if the difference between the conveyance period of time and the reference period of time is longer than a jam setting time.

The foregoing and/or other aspects and utilities of the present general inventive concept may also be achieved by providing a method of controlling an image forming apparatus, the method including measuring a conveyance period of time during which a sheet of paper is conveyed, comparing the measured conveyance period of time with a reference period of time, and controlling, if the measured conveyance period of time and the reference period of time are different, a pickup-related time of a next sheet of paper or displaying that a jam has occurred according to a difference between the measured conveyance period of time and the reference period of time.

A conveyance path where the sheet of paper is conveyed may be divided into a first section where an image is formed on a front side of the sheet of paper and a second section where an image is formed on a rear side of the sheet of paper.

When the sheet of paper is conveyed along the second section, an image has already been formed on the front side of the sheet of paper while the sheet of paper passed through the first section.

The image forming printing method may further include delaying a default pickup-related time by the difference between the measured conveyance period of time and the reference period of time if the difference is not longer than the jam setting time and displaying that a jam has occurred if the difference is longer than the jam setting time.

The second section may extend from one side of a paper exit unit to one side of a developing unit and the conveyance period of time is measured while the sheet of paper is conveyed along the second section.

The foregoing and/or other aspects and utilities of the present general inventive concept may also be achieved by providing an image forming apparatus including a driving unit to feed a sheet of paper and to drive a mechanism to form an image on the feed sheet, and a controller to control the driving unit to adjust a feeding time of the sheet and a driving time of the mechanism according to a conveyance period of time of the sheet.

The foregoing and/or other aspects and utilities of the present general inventive concept may also be achieved by providing a method to detect a recording-medium jam in an image forming apparatus, the method including measuring a conveyance time period in which the recording medium is conveyed along the conveyance path, determining a first time period by comparing the measured conveyance time with a predetermined period of time and determining whether the first time period is greater than a predetermined jam-setting time and, if so, detecting that the record-medium jam has occurred.

The foregoing and/or other aspects and utilities of the present general inventive concept may also be achieved by providing a computer-readable recording medium having embodied thereon a computer program to execute a method, wherein the method including measuring a conveyance time period in which a recording medium is conveyed along the conveyance path, determining a first time period by comparing the measured conveyance time with a predetermined period of time and determining whether the first time period is greater than a predetermined jam-setting time and, if so, detecting that the record-medium jam has occurred.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates the configuration of an image forming apparatus according to the present general inventive concept;

FIG. 2 illustrates the configuration of a driving system of the image forming apparatus according to an embodiment of the present general inventive concept;

FIG. 3 is a control block diagram of the image forming apparatus according to an embodiment of the present general inventive concept;

FIG. 4 illustrates operating timings of a pickup roller, a paper feed sensor, and a paper exit sensor when the image forming apparatus according to an embodiment of the present general inventive concept conveys paper normally;

FIG. 5 illustrates operating timings of a pickup roller, a paper feed sensor, and a paper exit sensor when an image forming apparatus according to an embodiment of the present general inventive concept delays paper conveyance; and

FIG. 6 is a flow chart of a method of controlling an image forming apparatus according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

A description will now be given of an image forming apparatus and a method of controlling the same according to an embodiment of the present general inventive concept.

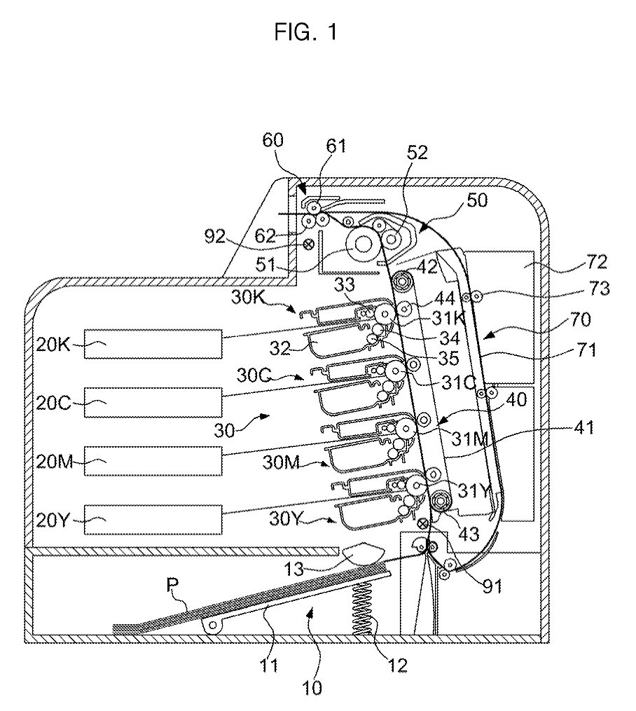

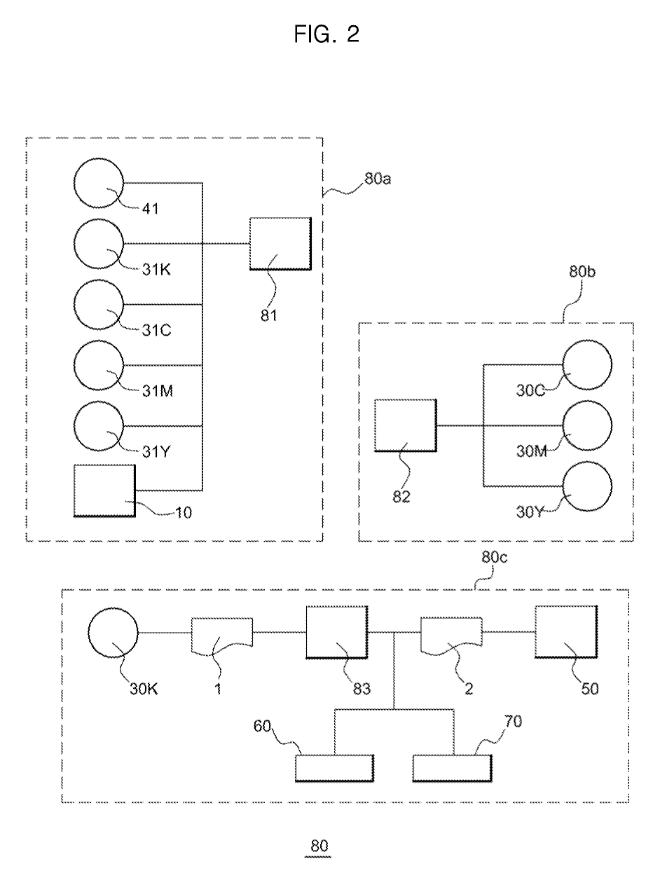

FIG. 1 is a sectional view illustrating a structure of an image forming apparatus according to an embodiment of the present general inventive concept and FIG. 2 illustrates a driving system of the image forming apparatus of FIG. 1 according to an embodiment of the present general inventive concept.

As illustrated in FIG. 1, the image forming apparatus according to the present embodiment includes a paper feed unit 10, an exposure unit 20, a developing unit 30, a transfer unit 40, a fusing unit 50, a paper exit unit 60, and a duplex printing unit 70.

The paper feed unit 10, which feeds sheets of paper P as print media, includes a paper tray 11 in which sheets of paper P are stacked and a spring 12 that elastically supports the paper tray 11. The sheets of paper stacked in the paper tray 11 are picked up one by one and then moved toward the developing unit 30.

The developing unit 30 includes four developing cartridges 30Y, 30M, 30C, and 30K that contain toner of different colors, for example, yellow (Y), magenta (M), cyan (C), and black (K) toner. The developing cartridges 30Y, 30M, 30C, and 30K include photosensitive bodies 31Y, 31M, 31C, and 31K on surfaces of which latent electrostatic images are formed by the exposure unit 20 which includes exposure devices 20Y, 20M, 20C, and 20K.

According to received print signals, the exposure devices 20Y, 20M, 20C, and 20K emit light beams corresponding to image information of the four colors (yellow (Y), magenta (M), cyan (C), and black (K)) to the photosensitive bodies 31Y, 31M, 31C, and 31K of the developing cartridges.

Each of the developing cartridges 30Y, 30M, 30C, and 30K includes a developing toner storage 32 in which toner used to develop an image is stored, an electrifying roller 33 to electrify a corresponding photosensitive body 31Y, 31M, 31C, or 31K, a developing roller 34 to develop a latent electrostatic image formed on the photosensitive body 31Y, 31M, 31C, or 31K into a toner image, and a supply roller 35 to attach toner to the developing roller 34.

The transfer unit 40 transfers a toner image developed on the photosensitive body to paper. The transfer unit 40 includes a transfer belt 41 which travels in a loop in contact with the photosensitive bodies 31Y, 31M, 31C, and 31K, a driving roller 42 to drive the transfer belt 41, a tension roller 43 to maintain constant tension of the transfer belt 41, and four transfer rollers 44 to transfer toner images developed on the photosensitive bodies 31Y, 31M, 31C, and 31K to paper.

The fusing unit 50 applies heat and pressure to paper to which a visual image has been transferred so that the image is fixed to the paper. The fusing unit 50 includes a heating roller 51 that has a heat source to apply heat to paper to which toner has been transferred and a pressure roller 52 that is provided opposite the heating roller 51 to maintain constant fusing pressure between the heating roller 51 and the pressure roller 52.

The paper exit unit 60 discharges printed paper to the outside and includes a paper exit roller 61 that receives motive power and is driven by the motive power and a paper exit backup roller 62 that is provided opposite the paper exit roller 61.

The duplex printing unit 70 conveys a sheet of paper, one side of which has been printed on, back to an upstream side of the developing unit 30 so that both the sides of the sheet of paper are printed on. The duplex printing unit 70 includes a guide frame 72 that forms a duplex print path 71 and a duplex printing roller 73 that is provided in the duplex print path 71 to convey paper.

A paper feed sensor 91 is provided at the upstream side of the developing unit 30 to sense whether a sheet of paper picked up by the pickup roller 13 of the paper feed unit 10 has entered the developing unit 30 and then to output a corresponding sensing signal.

A paper exit sensor 92 is provided near the paper exit unit 60 to sense paper that is discharged to the outside and to output a corresponding sensing signal.

As illustrated in FIG. 2, the image forming apparatus according to the present embodiment has a driving unit 80 to drive the above-mentioned components of the apparatus. The driving unit 80 includes a first driver 80a that is driven by a first drive motor 81, a second driver 80b that is driven by a second drive motor 82, and a third driver 80c that is driven by a third drive motor 83.

The first drive motor 81 drives the paper feed unit 10, the photosensitive bodies 31Y, 31M, 31C, and 31K of the developing unit 30, and the transfer belt 41 through a motive power transfer unit such as a coupling unit or a gear train.

The second drive motor 82 drives various rollers provided in the developing cartridges 30Y, 30M, and 30C of the three colors (yellow, magenta, and cyan) other than black.

The third drive motor 83 drives various rollers provided in the black developing cartridge 30K, the fusing unit 50, the paper exit unit 60, and the duplex printing unit 70. A motive power intermittence mechanism 1 is provided between the third drive motor 83 and the black developing cartridge 30K to intermittently transfer motive power of the third drive motor 83 to the black developing cartridge 30K. A one-way clutch 2 is provided between the third drive motor 83 and the fusing unit 50 to transfer motive power only in one direction.

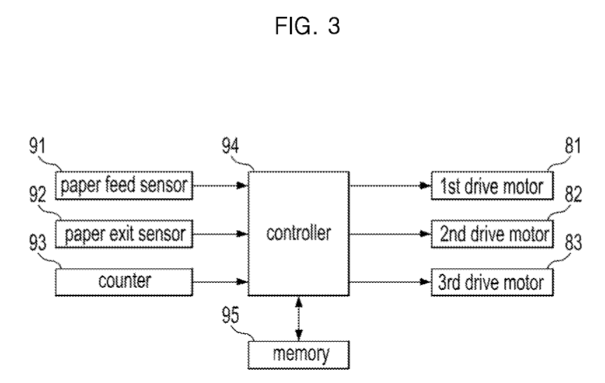

As illustrated in FIG. 3, a controller 94 controls drive operations of the first to third drive motors 81, 82, and 83 during duplex printing.

The controller 94 controls operations to print on the front side of each sheet of paper that is fed one by one by the paper feed unit 10 and to convey the sheet of paper back to the upstream side of the developing unit 30 through the duplex print path 71 and then to discharge the sheet of paper to the outside. To accomplish this control, the controller 94 receives sensing signals from the paper feed sensor 91 and the paper exit sensor 92.

While a sheet of paper is conveyed, a paper conveyance delay may occur due to slippage or interference. This paper delay time is counted by a counter 93 and is then provided to the controller 94.

The controller 94 compares the paper delay time received from the counter 93 with a reference time stored in memory 95 and controls a pickup-related time (pickup timing or pickup waiting period) to pickup of a next sheet of paper according to the difference between the paper delay time and the reference time. Specifically, according to the difference between the paper delay time and the reference time and/or the output of the paper feed or exit sensor 91 or 92, the controller 94 controls at least one of the first to third drive motors 81, 82, and 83 in order to control the pickup time of the next sheet of paper or the feed time of the current or next sheet of paper.

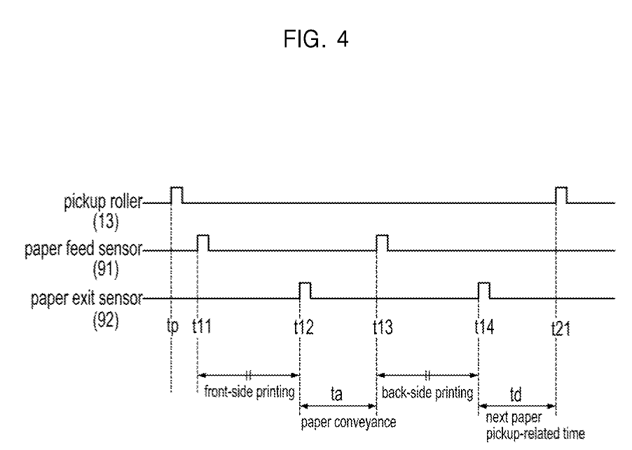

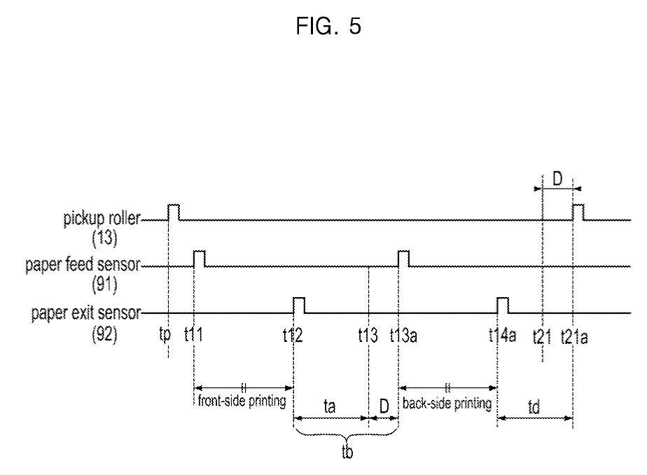

FIG. 4 illustrates operating timings of the pickup roller, the paper feed sensor, and the paper exit sensor when the image forming apparatus according to the present general inventive concept conveys paper normally. FIG. 5 illustrates operating timings of the pickup roller, the paper feed sensor, and the paper exit sensor when the image forming apparatus according to the present general inventive concept delays paper conveyance.

As illustrated in FIG. 4, the controller 94 drives the first to third drive motors 81, 82, and 83 to start duplex printing. Accordingly, the pickup roller 13 of the paper feed unit 10 picks up a sheet of paper at time tp. The paper feed sensor 91 outputs a sensing signal of the sheet of paper as the sheet of paper enters the developing unit 30 at time t11 after a specific time elapses from the pickup time tp. In response to this sensing signal, the controller 94 conveys the sheet of paper between the developing unit 30 and the transfer belt 41 so that toner images developed on the photosensitive bodies are transferred to a front side of the sheet of paper. While the sheet of paper passes through the fusing unit 50, visual images transferred to the front side of the sheet of paper are fixed thereof. After the printing of the front side of the sheet of paper is completed, the sheet of paper is conveyed toward the paper exit unit 60. When the sheet of paper passes through the paper exit unit 60, the paper exit sensor 92 outputs a corresponding sensing signal.

The controller 94 reverses the rotation of the third drive motor 83 at the moment when the rear end of the sheet of paper, whose front side has been printed, passes by the paper exit sensor 92 provided downstream of the fusing unit 50. As the third motor 83 rotates in reverse direction, the motive power intermittence mechanism 1 turns off motive power transferred to the black developing cartridge 30K and the one-way clutch 2 used to drive the fusing unit 50 turns off motive power transferred to the fusing unit 50. Then, only the paper exit and duplex printing rollers 61 and 73 rotate in reverse direction, whereby the sheet of paper is conveyed back to the upstream side of the developing unit 30 via the duplex print path 71. The counter 93 measures a conveyance period of time ta from the output time t12 of the paper exit sensor 92 to the output time t13 of the paper feed sensor 91 while the sheet of paper is conveyed via the duplex print path 71.

The third drive motor 83 again reverses its rotation at a specific time before the front end of the sheet of paper enters between the transfer belt and the photosensitive bodies 31Y, 31M, 31C, and 31K after passing through the duplex print path 71. Here, the motive power intermittence mechanism 1 transfers motive power of the third drive motor 83 to the black developing cartridge 30K.

As the sheet of paper enters the upstream side of the developing unit 30 by driving the first and second drive motors 81 and 82, the paper feed sensor 91 outputs a corresponding sensing signal. At time t13, the controller 94 causes the sheet of paper to be conveyed between the developing unit 30 and the transfer belt 41 so that an image is formed on the back side of the sheet of paper while the sheet of paper undergoes developing, transfer, and fusing processes. After undergoing these back-side printing processes, the sheet of paper is discharged to the outside through the paper exit unit 60. Here, as the sheet of paper passes through the paper exit unit 60, the paper exit sensor 92 outputs a corresponding sensing signal at time t14. From this time t14, the controller 94 waits for a pickup-related time (pickup waiting period) td to pickup a next sheet of paper. At time t21 when the next paper pickup waiting period td has elapsed, the controller 94 drives the first to third drive motors 81, 82, and 83 to start printing a next sheet of paper. Accordingly, the pickup roller 13 picks up and conveys the next sheet of paper to the upstream side of the developing unit 30. Thereafter, the controller 94 repeats duplex printing through the same operations as described above.

A description of operating timings of FIG. 5 will now be given focusing on printing processes subsequent to front-side printing, where a description of processes of picking up a sheet of paper and printing on a front side of the sheet of paper is omitted for ease of explanation.

The third drive motor 83 reverses its rotation at time t12 when the paper exit sensor 92 outputs a sensing signal of the sheet of paper as the sheet of paper passes through the paper exit unit 60 after front-side printing of the sheet of paper is completed. Accordingly, only the paper exit and duplex printing rollers rotate in reverse direction, thereby conveying the sheet of paper back to the upstream side of the developing unit 30 via the duplex print path 71.

Thereafter, the sheet of paper is conveyed between the developing unit 30 and the transfer belt 41 so that an image is formed on the back side of the sheet of paper while the sheet of paper undergoes developing, transfer, and fusing processes. After undergoing these back-side printing processes, the sheet of paper is discharged to the outside through the paper exit unit 60.

On occasion that the conveyance is delayed while the sheet of paper is conveyed via the duplex print path 71, a conveyance period of time tb that the counter 93 measures until the sheet of paper enters the upstream side of the developing unit 30 at time t13a is longer than a reference conveyance period of time ta that elapses while the sheet of paper is conveyed normally. The subsequent processes are delayed by a delay time D corresponding to the difference between the conveyance periods of time tb and ta. Accordingly, from this time t14a, the controller 94 waits for a pickup-related time (or pickup waiting period) td to pickup a next sheet of paper. This waiting period is terminated at time t21a which is a delayed time of the preset time t21 by the delay time D.

If a next sheet of paper is picked up at the preset time t21 although the conveyance has been delayed, a multifeed or jam may occur since the interval of time between the previous and next sheets of paper is not enough. Accordingly, at time t21a which is a delayed time of the preset time t21 by the delay time D, the controller 94 picks up the next sheet of paper using the pickup roller 13.

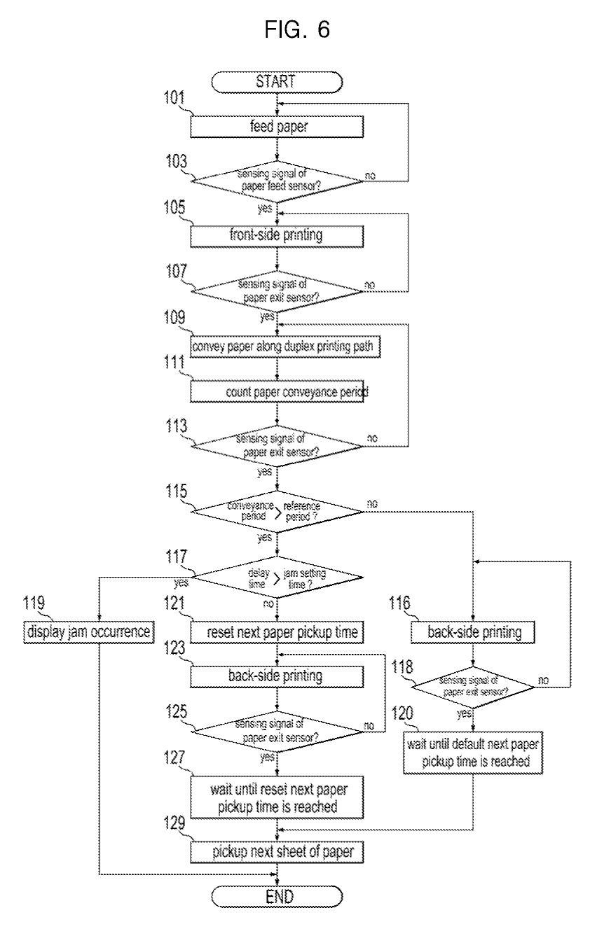

A method of controlling the image forming printing method configured as described above according to the present general inventive concept will now be described with reference to FIG. 6.

The controller 94 drives the first drive motor 81 to provide a sheet of paper from the paper feed unit 10 to the developing unit 30 (operation 101).

When receiving a sensing signal from the paper feed sensor 91, the controller 94 drives the second and third drive motors 82 and 83 to form an image on a front side of the sheet of paper (operation 105). After front-side printing is completed, the sheet of paper passes through the paper exit unit 60. Here, when receiving a sensing signal from the paper exit sensor 92, the controller 94 deactivates the first and second motors 81 and 82 and reverses the rotation of the third drive motor 83. This causes the sheet of paper to be conveyed back to the upstream side of the developing unit 30 via the duplex print path 71 (operation 109). Here, the counter 93 counts a paper conveyance period of time (operation 111).

The controller 94 then determines whether the controller has received a sensing signal from the paper feed sensor 91. When the controller has received the sensing signal, the controller 94 determines whether the conveyance period of time measured by the counter 93 is longer than a reference period of time (operation 115). If the determination is that the measured conveyance period of time is longer than a reference period of time, the controller 94 determines that the sheet of paper has been conveyed normally and again reverses the rotation of the third drive motor 83 and drives the first and second drive motors 81 and 82 to form an image on a back side of the sheet of paper (operation 116). During the back-side printing, the controller 94 determines whether the controller has received a sensing signal from the paper exit sensor 92 (operation 118). When the controller has received the sensing signal, the controller 94 waits until a default next paper pickup time t21 is reached (operation 120) and then picks up a next sheet of paper.

Alternatively, if the determination of operation 115 is that the conveyance period of time is longer than the reference period of time, the controller 94 determines that the conveyance has been delayed and determines whether a delay time corresponding to the difference between the conveyance period of time and the reference period of time is greater than a preset jam setting time (operation 117). If the delay time is greater than a preset jam setting time, the controller 94 displays that a jam has occurred so that the user checks the jam and then stops the printing operation (operation 119).

If the determination of operation 117 is that the delay time is not greater than the jam setting time, the controller 94 again reverses the rotation of the third drive motor 83 and drives the first and second drive motors 81 and 82 to form an image on the back side of the sheet of paper (operation 123). During the back-side printing, the controller 94 determines whether the controller has received a sensing signal from the paper exit sensor 92 (operation 125). When the controller has received the sensing signal, the controller 94 waits until a next paper pickup time t21a that has been reset taking into consideration the delay time corresponding to the difference between the conveyance period of time and the reference period of time (operation 127).

When the waiting period for next paper pickup is terminated, the controller 94 performs an operation to pick up a next sheet of paper from the paper cassette (operation 129).

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As is apparent from the above description, the present general inventive concept provides an image forming apparatus and a method of controlling the same, which control a pickup-related time to pickup a next sheet of paper so that a conveyance delay of a sheet of paper does not negatively affect the subsequent processes even if the conveyance delay occurs due to slippage or interference while the sheet of paper is conveyed to perform duplex printing, thereby increasing reliability of the image forming apparatus.

Although various embodiments of the present general inventive concept have been illustrated and described, it would be appreciated by those skilled in the art that changes may be made in these embodiments without departing from the principles and spirit of the general inventive concept, the scope of which is defined in the claims and their equivalents.

What is claimed is:

1. An image forming apparatus, comprising:
a plurality of paper sensors to sense a sheet of paper conveyed along a conveyance path;
a counter to measure a conveyance period of time, during which the sheet of paper is conveyed, based on a sensing signal from the plurality of paper sensors; and
a controller to control, if the conveyance period of time measured by the counter and a reference period of time are different, a pickup-related time of a next sheet of paper or to display that a jam has occurred according to a difference between the measured conveyance period of time and the reference period of time.

2. The image forming apparatus according to claim 1, wherein the plurality of paper sensors comprises:
a paper feed sensor to detect feed of a sheet of paper; and
a paper exit sensor to detect exit of a sheet of paper.

3. The image forming apparatus according to claim 1, wherein the controller controls the pickup-related time of the next sheet of paper according to a difference between the reference period of time and a conveyance period of time during which the sheet of paper is conveyed along one section of the conveyance path where an image is formed on a rear side of the sheet of paper.

4. The image forming apparatus according to claim 1, wherein the controller delays a default paper pickup-related time by the difference between the conveyance period of time and the reference period of time if the difference is not longer than a jam setting time.

5. The image forming apparatus according to claim 1, wherein the controller displays that a jam has occurred if the difference between the conveyance period of time and the reference period of time is longer than a jam setting time.

6. A method of controlling an image forming apparatus, the method comprising:
measuring a conveyance period of time during which a sheet of paper is conveyed;
comparing the measured conveyance period of time with a reference period of time; and
controlling, if the measured conveyance period of time and the reference period of time are different, a pickup-related time of a next sheet of paper or displaying that a jam has occurred according to a difference between the measured conveyance period of time and the reference period of time.

7. The image forming printing method according to claim 6, wherein a conveyance path where the sheet of paper is conveyed is divided into a first section where an image is formed on a front side of the sheet of paper and a second section where an image is formed on a rear side of the sheet of paper.

8. The image forming printing method according to claim 7, wherein, when the sheet of paper is conveyed along the second section, an image has already been formed on the front side of the sheet of paper while the sheet of paper passed through the first section.

9. The image forming printing method according to claim 6, wherein further comprising:
delaying a default pickup-related time by the difference between the measured conveyance period of time and the reference period of time if the difference is not longer than the jam setting time and displaying that a jam has occurred if the difference is longer than the jam setting time.

10. The image forming printing method according to claim 7, wherein the second section extends from one side of a paper exit unit to one side of a developing unit and the conveyance period of time is measured while the sheet of paper is conveyed along the second section.

11. An image forming apparatus, comprising;
a driving unit to feed a sheet of paper and to drive a mechanism to form an image on the feed sheet; and
a controller to control the driving unit to adjust a feeding time of the sheet and a driving time of the mechanism according to a conveyance period of time of the sheet.

12. A method to detect a recording-medium jam in an image forming apparatus, the method comprising:
measuring a conveyance time period in which the recording medium is conveyed along the conveyance path;
determining a first time period by comparing the measured conveyance time with a predetermined period of time; and
determining whether the first time period is greater than a predetermined jam-setting time and, if so, detecting that the record-medium jam has occurred.

13. A computer-readable recording medium having embodied thereon a computer program to execute a method, wherein the method comprises:
measuring a conveyance time period in which a recording medium is conveyed along the conveyance path;
determining a first time period by comparing the measured conveyance time with a predetermined period of time; and
determining whether the first time period is greater than a predetermined jam-setting time and, if so, detecting that the record-medium jam has occurred.
